(19) United States
(12) Patent Application Publication
(10) Pub. No.: US 2025/0018540 A1
(43) Pub. Date: Jan. 16, 2025

(54) COMBINATION TOOL

(71) Applicants: Hangzhou United Tools Co., Ltd., Hangzhou City (CN); Hangzhou Great Star Industrial Co., Ltd., Hangzhou City (CN)

(72) Inventor: Yueming Li, Hangzhou City (CN)

(73) Assignees: Hangzhou United Tools Co., Ltd., Hangzhou City, ZJ (CN); Hangzhou Great Star Industrial Co., Ltd., Hangzhou City, ZJ (CN)

(21) Appl. No.: 18/902,103

(22) Filed: Sep. 30, 2024

Related U.S. Application Data
(63) Continuation-in-part of application No. 17/707,573, filed on Mar. 29, 2022.
Application No. 17/707,573 is a continuation-in-part of application No. PCT/CN2019/113219, filed on Oct. 25, 2019.

(51) Int. Cl. B25B 15/00; B25F 1/02; B25G 1/08; B44D 3/16

(52) U.S. Cl. CPC B25B 15/00; B25F 1/02; B25G 1/08; B44D 3/162

(57) ABSTRACT

The present application discloses a combination tool characterized in comprising: a first tool component comprising a working portion and a grip portion, which are coupled to each other, the grip portion defining a tool receptacle; at least one second tool component having a different function from that of the tool component, the second tool component detachably engaged in the tool receptacle; and a damping mechanism configured to prevent the second tool component from dislodging from the grip portion in the absence of an external force acting thereon.

### RELATED APPLICATIONS

This application is a continuation-in-part (CIP) application claiming benefit of U.S. patent application Ser. No. 17/707,573 filed on Mar. 29, 2022, which is a continuation-in-part (CIP) application claiming benefit of PCT/CN2019/113219 filed on Oct. 25, 2019. The disclosures of those applications are incorporated herein in their entirety by reference.

### FIELD OF THE INVENTION

This application relates to the field of hand tools and, in particular, to a multifunctional combination tool.

### DESCRIPTION OF THE PRIOR ART

Various hand tools like scrapers are indispensable to the fields of engineering construction, building decoration, etc. Scrapers, also known as putty knives, are hand tools commonly used by painters and plasterers. With scraping, shoveling, spreading and caulking capabilities, scrapers are widely used in building construction and in our daily lives. Conventional scrapers are typically composed of a scraper blade and a handle to which the scraper blade is secured. The scraper blade is typically made of a rigid material and serves as the scraper's primary working part, whilst the handle is for gripping by an operator. Existing scrapers typically have only the basic scraping or shoveling capabilities, so in practice, for a surface being worked upon where there is a screw or other fixed obstacle needing to be removed, the operator typically has to resort to a screwdriver, knife blade, crowbar or other tool to perform the obstacle removal or surface cleaning task. This requires the operator to carry with him/her a comprehensive set of various hand tools and search for different tools from time to time during operation, thus creating inconvenience of tool carrying and adversely affecting operating convenience, speed and hence efficiency.

Therefore, effort in the art is being directed toward developing a multifunctional scraper tool incorporating tools with other functions.

### SUMMARY OF THE INVENTION

In view of the above described shortcomings of the prior art, this application aims to structurally retrofit existing scrapers and make them multifunctional.

This application provides a combination tool comprising: a first tool component comprising a working portion and a grip portion, which are coupled to each other; and a second tool component detachably mounted on the grip portion of the first tool component.

In some embodiments, optionally, the grip portion is provided with a tool receptacle in which the second tool component is detachably disposed.

In some embodiments, optionally, a damping mechanism is additionally included for preventing accidental disengagement of the second tool component from the first tool component.

In some embodiments, optionally, the damping mechanism comprises a protrusion, which is disposed on at least one inner wall of the tool receptacle so as to stop the second tool when it is being inserted in the tool receptacle.

In some embodiments, optionally, the damping mechanism comprises an anti-slip coating provided on at least one inner wall of the tool receptacle.

In some embodiments, optionally, the damping mechanism comprises a magnetic element embedded in the grip portion.

In some embodiments, optionally, the damping mechanism comprises an elastic mechanism, which is provided on the second tool so as to abut against an inner wall of the tool receptacle when the second tool is inserted in the tool receptacle and thus prevent accidental disengagement of the second tool from the tool receptacle.

In some embodiments, optionally, the first tool component is a scraper and the working portion is a scraper blade, with the grip portion being a handle and secured to a leading end of the working portion.

In some embodiments, optionally, the tool receptacle is provided in a side surface of the grip portion.

In some embodiments, optionally, the tool receptacle is flat in shape.

In some embodiments, optionally, the second tool is a Phillips bit or a knife blade, which is configured to be retractably disposed in the tool receptacle.

In some embodiments, optionally, the tool receptacle is provided, around an externally exposed end thereof, with a depression for facilitating retraction of the second tool.

In some embodiments, optionally, the depression assumes a shape that is corresponding to fingers.

In some embodiments, optionally, the tool receptacle is an L-shaped cavity having a long arm extending longitudinally on a surface of the grip portion and a short arm extending transversely toward the interior of the grip portion.

In some embodiments, optionally, the second tool is an L-shaped bit or a hammer.

In some embodiments, optionally, the tool receptacle transversely extends through the grip portion.

In some embodiments, optionally, the tool receptacle is provided at a trailing end of the grip portion.

In some embodiments, optionally, the tool receptacle is a longitudinal cavity that is open at the trailing end of the grip portion.

In some embodiments, optionally, an end cap is additionally included, which is mounted at the opening of the tool receptacle such as to be able to open or close the opening.

In some embodiments, optionally, the second tool is a linear bit.

In some embodiments, optionally, the second tool is a tape measure.

The present application also provides a multifunctional scraper comprising a scraper blade and a handle coupled to the scraper blade. The multifunctional scraper further comprises a second tool, and the handle is provided with a tool receptacle adapted to the second tool in terms of shape and size. The second tool can be movably inserted in the tool receptacle.

Optionally, a damping mechanism is provided in the tool receptacle.

Optionally, the damping mechanism is an anti-slip silicone coating, or a protruding snap element, or a magnetic element.

Optionally, the damping mechanism is provided on at least one inner wall of the tool receptacle.

Optionally, the damping mechanism is provided at the bottom of the tool receptacle.

Optionally, the magnetic element is magnetic steel.

Optionally, the second tool is a Phillips screwdriver bit or a knife blade.

Optionally, the tool receptacle is provided in a middle portion of the handle.

Optionally, the second tool is a linear screwdriver bit.

Optionally, the tool receptacle transversely extends through the handle.

Optionally, at a trailing end of the handle, a longitudinal tool receptacle and an end cap are additionally provided, which together delimits a cavity in which the linear screwdriver bit is received.

Optionally, the end cap is attached to the handle threadedly or by means of an elastic element.

Optionally, the second tool is an L-shaped bit tool.

Optionally, the second tool is a hammer defining a hammer working portion and a screwdriver bit respectively at its opposite ends.

Optionally, the tool receptacle is provided with a curved depression around its externally exposed end.

Optionally, the tool receptacle is provided at the trailing end of the handle.

Optionally, the second tool is a tape measure.

In order to integrate multiple tool components, the present application provides a combination tool comprising:
a first tool component comprising a working portion and a grip portion, which are coupled to each other, the grip portion defining a tool receptacle;
at least one second tool component having a different function from that of the tool component, the second tool component detachably engaged in the tool receptacle; and
a damping mechanism configured to prevent the second tool component from dislodging from the grip portion in the absence of an external force acting thereon.

Additionally, the second tool component may comprise a Phillips screwdriver bit, which is a screwdriver bit with four Phillips bit working portions extending in four mutually perpendicular directions.

Additionally, the Phillips screwdriver bit may define a through slot in its central portion, which is configured to detachably engage a first screwdriver bit and actuate rotation of the first screwdriver bit under an action of an external force.

Additionally, the first screwdriver bit may be received in a working receptacle in the grip portion.

Additionally, the working receptacle may extend in a lengthwise direction of the grip portion.

Additionally, a retention insert may be provided on a side wall in the tool receptacle and configured to come into contact with the Phillips screwdriver bit and restrict and support the Phillips screwdriver bit.

Additionally, the retention insert may comprise a first retention insert and a second retention insert, which are separate from and arranged in opposition to each other and come into contact with respective opposite ends of the Phillips screwdriver bit.

Additionally, the first retention insert and the second retention insert may each comprise raised portions at opposite ends and a recessed portion between the raised portions, the raised portions configured to come into contact with the Phillips screwdriver bit.

Additionally, the Phillips screwdriver bit may be provided with a pull-out feature configured for the Phillips screwdriver bit to be pulled out of the tool receptacle under an action of an external force.

Additionally, the pull-out feature may be a rope-like feature passed through a slot in the Phillips screwdriver bit.

Additionally, the tool receptacle may define, in its side wall, an avoidance feature capable of receiving the rope-like feature therein.

Additionally, the grip portion may define, at its end proximate the first working portion, an extraction component configured to be able to open a cover of a container in the form of a can under an action of an external force.

Additionally, the extraction component may comprise a protrusion extending from the end of the grip portion in a lengthwise direction of the grip portion, the protrusion in opposition to the first tool component, wherein the first tool component forms a lever member of the extraction component, and the protrusion provides a point of force application for the extraction component.

Additionally, the first tool component may be a scraper.

Additionally, the damping mechanism may comprise:
a protruding snap element provided at an opening of the tool receptacle; and/or
an anti-slip coating provided inside the tool receptacle; or/or
a magnetic attraction means provided in the tool receptacle.

The present application also provides a combination tool comprising:
a first tool component comprising a working portion and a grip portion, which are coupled to each other, the grip portion defining a tool receptacle;
at least one second tool component having a different function from that of the tool component, the second tool component detachably engaged in the tool receptacle,
wherein the second tool component comprises a Phillips screwdriver bit detachably received in the tool receptacle; and
a retention insert disposed in the tool receptacle to restrict and support the Phillips screwdriver bit in the tool receptacle.

Additionally, the retention insert comprises a first retention insert and a second retention insert, which are disposed on an inner wall of the tool receptacle.

Additionally, the Phillips screwdriver bit defines a through slot in its central portion, which is configured to detachably engage a first screwdriver bit, and is configured to actuate rotation of the first screwdriver bit under an action of an external force.

Additionally, the first screwdriver bit is detachably engaged in a working receptacle in the grip portion.

Additionally, the grip portion is provided at its end proximate the first working portion with an extraction component configured to be able to open a cover of a container in the form of a can under an action of an external force.

Apart from the basic scraping and shoveling capabilities of common scrapers, the above multifunctional scraper further incorporates the second tool through receiving it in the tool receptacle provided in the handle while not compromising a grip feel or outer appearance. Thus, the scraper can be used in multifunctional applications and conveniently carried and used by an operator.

For a full understanding of the objects, features and effects of the present application, the concept, structural details and resulting technical effects will be further described with reference to the accompanying drawings.

### BRIEF DESCRIPTION OF THE DRAWINGS

FIG. 1 is a schematic diagram showing the structure of a multifunctional scraper according to an embodiment of the present application;

FIG. 2 is a schematic exploded view of a multifunctional scraper according to another embodiment of the present application;

FIG. 3 is a side cutaway view of the multifunctional scraper of FIG. 2;

FIG. 4 is a schematic diagram showing the structure of a Phillips screwdriver bit in the multifunctional scraper of FIG. 2;

FIG. 5 is a schematic exploded view of a multifunctional scraper according to a further embodiment of the present application;

FIG. 6 is a schematic diagram showing the structure of a multifunctional scraper according to a further embodiment of the present application;

FIG. 7 is a schematic exploded view f the multifunctional scraper of FIG. 6;

FIG. 8 is a side cutaway view of the multifunctional scraper of FIG. 6;

FIG. 9 is a schematic diagram showing the structure of a first linear screwdriver bit in the multifunctional scraper of FIG. 6;

FIG. 10 is a schematic diagram showing the structure of a multifunctional scraper according to a further embodiment of the present application;

FIG. 11 is a side cutaway view of the multifunctional scraper of FIG. 10;

FIG. 12 is a schematic diagram showing the structure of an L-shaped bit tool in the multifunctional scraper of FIG. 10;

FIG. 13 a cutaway view of a multifunctional scraper according to a further embodiment of the present application;

FIG. 14 is a schematic diagram showing the structure of a hammer in the multifunctional scraper of FIG. 13;

FIG. 15 is a schematic diagram showing the structure of a multifunctional scraper according to a further embodiment of the present application.

FIG. 16 is a schematic diagram showing the structure of a combination tool according to a further embodiment of the present application.

FIG. 17 is an exploded view of part of FIG. 16, showing a Phillips screwdriver bit and a corresponding receptacle;

FIG. 18 is an enlarged view of part of FIG. 17, showing the structure of the Phillips screwdriver bit and the receptacle;

FIG. 19 is an exploded view of FIG. 18, showing a retention insert;

FIG. 20 is a front view of FIG. 16;

FIG. 21 is a schematic partially exploded plan view of FIG. 20;

FIG. 22 is a back view of FIG. 16, showing the location of a separate screwdriver bit in a handle;

FIG. 23 is a left view of FIG. 20;

FIG. 24 is a schematic cross-sectional view taken along B-B of FIG. 23;

FIG. 25 is a schematic exploded view of FIG. 16; and

FIG. 26 is a schematic enlarged view of part of FIG. 25.

### DETAILED DESCRIPTION OF THE PREFERRED EMBODIMENTS

A few preferred embodiments of the present application are described below with reference to the drawings accompanying so that the techniques disclosed herein become more apparent and better understood. The present application may be embodied in many different forms, and its scope sought to be protected hereby is not limited only to the embodiments disclosed herein.

Throughout the accompanying drawings, structurally identical parts are indicated with the identical reference numerals, and structurally or functionally similar components are indicated with similar reference numerals. In the drawings, the size and thickness of each component are arbitrarily depicted, and the present application is not limited to the size or thickness of any component. For greater clarity of illustration, the thicknesses of some parts may be exaggerated somewhere in the drawings.

This application provides a combination tool including a first tool component and a second tool component. The first tool component includes a working portion and a grip portion, which are coupled to each other. The grip portion is provided with a tool receptacle in which the second tool component is detachably disposed. The combination tool may further include a damping mechanism for preventing accidental disengagement of the second tool component from the first tool component. The combination tool of the present application will be described below with the first tool component being implemented as a scraper as an example.

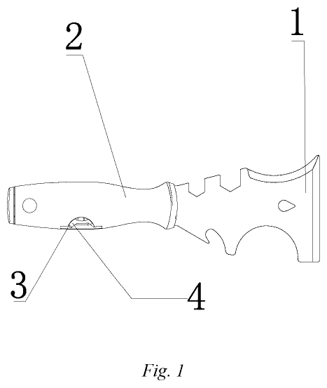

Reference is now made to FIG. 1, a schematic diagram showing the structure of a multifunctional scraper according to an embodiment of the present application. This application provides a multifunctional scraper including a scraper blade 1 and a handle 2 secured to the scraper blade 1. The scraper blade 1 is adapted to perform a scraping or shoveling function of the multifunctional scraper and serves as a primary working part of the multifunctional scraper. It is typically made from a metallic or ceramic material. For example, the metallic material may be an aluminum alloy, aluminum or steel material. The handle 2 is typically a wooden, plastic, ceramic or steel handle. The handle 2 secured to the scraper blade 1 is a portion of the multifunctional scraper to be gripped by a hand. An operator can conveniently use the tool through gripping the handle.

Differing from existing scrapers, the multifunctional scraper of the present embodiment further includes a tool receptacle 3 and a second tool 4. The tool receptacle 3 is provided in the handle 2 and adapted to the second tool 4 in terms of shape and size. The second tool 4 can be movably inserted in the tool receptacle 3.

In the present embodiment, the tool receptacle 3 is provided to accommodate the second tool 4 in a space of the handle 2. Therefore, the tool receptacle 3 is provided in a body of the handle 2. The tool receptacle 3 may be formed either integrally with the handle 2, or later in the handle 2 by machining, as long as the second tool 4 can be received therein while not affecting the operator's comfort when gripping the handle 2 with his/her hand.

For example, as shown in FIG. 1, the tool receptacle 3 is provided in a middle portion of the handle 2. Of course, according to the present application, the tool receptacle 3 may also be provided elsewhere in the handle 2, e.g., at a trailing end of the handle 2, along an axis of the handle 2, or transversely to the handle 2. It may be provided as described previously, so a further description is omitted.

As the tool receptacle 3 is intended mainly to accommodate the second tool 4, it shall be adapted to the second tool 4 to be accommodated therein in terms of shape, size, depth, opening width and other dimensions. For example, the second tool 4 may be a Phillips screwdriver bit. Of course, another tool suitable to be placed in the handle 2, such as a knife blade, a tape measure or a screwdriver bit in a different form, may also be placed therein as needed.

Therefore, by providing the tool receptacle 3 in the handle 2 of the multifunctional scraper and disposing the second tool 4 such as a screwdriver bit or a knife blade therein, the second tool 4 can be conveniently carried, and rapidly picked up or stowed, by the operator such as a painter during operation. To this end, the second tool 4 is movably inserted in the tool receptacle 3, and this movable insertion may be accomplished in a non-fastening manner involving contact and friction between surfaces of the second tool 4 and the tool receptacle 3, snap elements or the like, and requires the tool receptacle 3 to be adapted to the second tool 4 in terms of size and shape.

During the performance of a scraping or shoveling operation by the operator using the multifunctional scraper, when there is a need to use the second tool 4 such as a screwdriver bit or knife blade, he/she can take the second tool 4 out of the handle 2, and put it back into the tool receptacle 3 in the handle 2 after the use. Thus, it is both conveniently accessible for use and not easily lost.

In the multifunctional scraper of the present application, the second tool 4 is movably inserted in the tool receptacle 3. Considering the second tool 4 and/or the handle 2 is/are usually made of a metallic material, plastic or the like, in order to achieve greater friction and guarantee, to a certain extent, stable stay of the second tool 4 in the tool receptacle 3, an anti-slip measure may be taken in the present embodiment. For example, a damping mechanism may be arranged on at least one inner wall of the tool receptacle 3. For example, the damping mechanism may be provided at the bottom of the tool receptacle 3. For example, the damping mechanism may be an elastic snap element, or a magnetic element, or an anti-slip silicone coating.

For example, the elastic snap element may be disposed at the bottom or on a side wall in the tool receptacle 3. The magnetic element may be magnetic steel, which may also be referred to as a magnet. The magnetic element may be disposed at the bottom of the tool receptacle 3. The anti-slip silicone coating may be arranged on at least one inner wall of the tool receptacle 3. For example, the anti-slip silicone coating may be provided on a bottom surface, an inner circumferential surface or all the inner surfaces of the tool receptacle 3. Of course, other anti-slip materials or measures are also possible. This can additionally enhance the utility and convenience of use of the multifunctional scraper of this application.

According to another embodiment of the present application, the second tool 4 placed in the tool receptacle 3 may also be a Phillips screwdriver bit, a knife blade, or another tool.

For example, when the second tool 4 is a Phillips screwdriver bit or a knife blade, the tool receptacle 3 is provided in a middle portion of the handle, and the Phillips screwdriver bit or knife blade is movably inserted in the tool receptacle 3. The Phillips screwdriver bit or knife blade can be taken out of the tool receptacle 3 for use. In order to prevent the Phillips screwdriver bit or knife blade from easily slipping out of tool receptacle 3, a damping mechanism is provided on at least one inner wall of the tool receptacle 3. For example, the damping mechanism may be a protruding snap element, or a magnetic element, or an anti-slip silicone coating. For example, a protruding elastic snap element may be integrally formed with at least one inner wall of the tool receptacle 3, or another damping mechanism in a different form may be provided thereon, as long as it can keep the Phillips screwdriver bit or knife blade stably staying in the tool receptacle 3.

In another embodiment of this application, a linear screwdriver bit or a reversible bit, another type of commonly used hand tool, may be disposed, as the second tool, in the tool receptacle 3 in the multifunctional scraper of the present embodiment. For example, the tool receptacle 3 may transversely extend through the handle 2 and thus form a linear through hole. Due to the transverse extension, either one or more than one, e.g., two or three, of such tool receptacles 3 may be provided, depending principally upon a length of the handle 2 as well as the size of the screwdriver bit. The linear screwdriver bit can also be movably inserted in the tool receptacle 3, i.e., transversely placed in the through hole in the handle 2. Because of the structural nature of the through hole, the linear screwdriver bit received therein can be conveniently removed from either side thereof.

In another embodiment of this application, in order for even higher spatial utilization to be achieved, another tool receptacle extending longitudinally with respect to the handle 2 may be provided at the trailing end of the handle 2. For example, in the case of providing the tool receptacle 3 extending longitudinally with respect to the handle 2 at the trailing end of the handle 2, an end cap may be additionally provided at the trailing end of the handle 2. The end cap is threadedly coupled to the handle 2. When the end cap is tightened on the handle, it will delimit, together with the longitudinal tool receptacle 3, an enclosed cavity in which the linear screwdriver bit can be placed. When there is a need to use the linear screwdriver bit in the cavity, the end cap can be turned and removed to allow the linear screwdriver bit to be accessed for use. As used in this specification, the linear screwdriver bit refers to a linearly-shaped screwdriver bit with bit working portions at both ends. The two bit working portions may be identical. Of course, they may also be different.

In the multifunctional scraper of the present embodiment, apart from the Phillips screwdriver bit, knife blade or linear screwdriver bit as described and illustrated above, the second tool 4 may also be implemented as an L-shaped bit tool or a hammer.

In case of the second tool 4 being implemented as an L-shaped bit or a hammer, the tool receptacle 3 is adapted to the L-shaped tool or hammer in terms of size and shape, and the L-shaped bit is movably inserted in the tool receptacle. In the present embodiment, the L-shaped bit is a bit tool component in a shape like the letter L and with working portions at both ends, one of which is a screwdriver bit and the other is a crowbar claw. In the present embodiment, the hammer, as a type of commonly used hand tool, also has two ends, one of which may define a hammer working portion that can be used to strike an object with its own gravity, and the other may define a screwdriver bit, which is a movably fixed screwdriver bit, for example.

In the multifunctional scraper of the present embodiment, in order to allow more convenient removal of the second tool 4 inserted in the tool receptacle 3, a curved depression may be formed, for example, by cutting, around an externally exposed end of the tool receptacle 3. It is to be particular noted that, in the present embodiment, the curved depression is formed by additionally machining the handle 2 to further remove the material thereof around the externally exposed end of the tool receptacle 3. With the curved depression, part of an interface of the second tool 4, especially a portion thereof allowing convenient access by the operator, is exposed. Such a profile enables the operator to more conveniently to pull and remove the second tool 4 from the tool receptacle 3.

In another embodiment of this application, when the second tool 4 is made of a steel material, a magnetic element, such as magnetic steel, may be additionally embedded at the bottom of the tool receptacle 3 so that the second tool 4 can be kept in the tool receptacle 3 by an attractive magnetic force from the magnetic element.

In addition, tape measures are a type of measuring tools commonly used in the fields of building construction, engineering decoration, etc. The multifunctional scraper of this application can additionally incorporate the functionality of a tape measure. In case of the second tool 4 being implemented as a tape measure, the tool receptacle 3 is provided at the trailing end of the handle 2, and the tape measure may be movably inserted in the tool receptacle 3 at the trailing end of the handle 2.

The multifunctional scraper of the present application will be further described below additionally in connection with specific examples of the second tool.

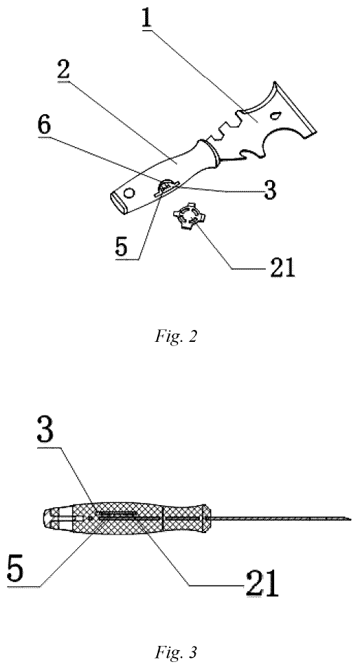

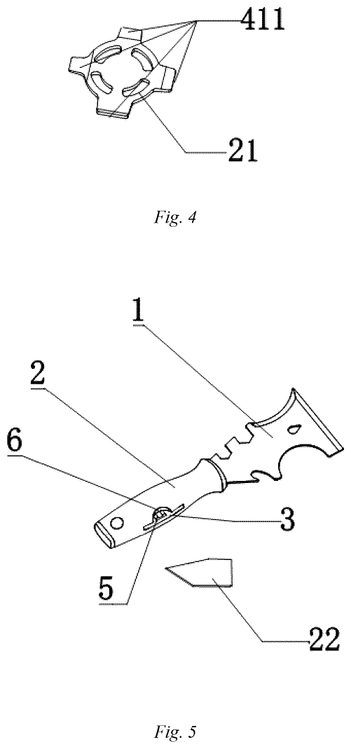

Reference is now made to FIG. 2, a schematic exploded view of the structure of a multifunctional scraper according to another embodiment of the present application. In the present embodiment, the multifunctional scraper includes a scraper blade 1, a handle 2 and a Phillips screwdriver bit 21. The Phillips screwdriver bit 21 serves as a second tool, and a tool receptacle 3 is provided in a middle portion of the handle 2. The tool receptacle 3 is adapted to the Phillips screwdriver bit 21 in terms of shape and size. For example, as shown in FIG. 3, the Phillips screwdriver bit 21 can be movably inserted in the tool receptacle 3.

The Phillips screwdriver bit 21 may be, as shown in FIG. 4, a screwdriver bit with four Phillips bit working portions 211 extending in four mutually perpendicular directions. In order to provide the operator with more options and greater convenience, each Phillips bit working portion 211 may have a different function.

On an inner wall of the tool receptacle 3, a protruding snap element 5 is provided. For example, the protruding snap element 5 is integrally formed and can securely lodge the Phillips screwdriver bit 21 within the tool receptacle 3 and prevent it from slipping out of the tool receptacle 3.

In order to enable the Phillips screwdriver bit 21 to be conveniently pulled and removed from or placed back into the tool receptacle 3, a curved depression 6 is provided around an externally exposed end of the tool receptacle 3. The curved depression 6 may be formed, for example, by a cutting process.

In order to more securely keep the Phillips screwdriver bit 21 in the tool receptacle 3, an anti-slip silicone coating is provided on a side wall of the tool receptacle 3 to increase friction between surfaces of the tool receptacle 3 and the Phillips screwdriver bit 21, thus preventing easy dislodgement of the Phillips screwdriver bit 21 from the tool receptacle 3.

Thus, during use of the multifunctional scraper of the present embodiment by the operator, when there is a need to use the Phillips screwdriver bit 21, he/she can take it out of the handle 2 for use.

Reference is now made to FIG. 5, a schematic exploded view of the structure of a multifunctional scraper according to a further embodiment of the present application. The multifunctional scraper of the present embodiment includes a scraper blade 1, a handle 2 and a knife blade 22. The knife blade 22 serves as a second tool, and a tool receptacle 3 is provided in a middle portion of the handle 2. The tool receptacle 3 is adapted to the knife blade 22 in terms of shape and size. The knife blade 22 can be movably inserted in the tool receptacle 3.

On an inner wall of the tool receptacle 3, a protruding snap element 5 is provided. For example, the protruding snap element 5 is integrally formed and can securely lodge the knife blade 22 within the tool receptacle 3 and prevent the knife blade 22 from slipping out of the tool receptacle 3.

In order to enable the knife blade 22 to be conveniently pulled and removed from or placed back into the tool receptacle 3, a curved depression 6 is provided around an externally exposed end of the tool receptacle 3. For example, the curved depression 6 may be formed by cutting around the externally exposed end of the tool receptacle 3.

In order to more securely keep the knife blade 22 in the tool receptacle 3, an anti-slip silicone coating is provided on a side wall of the tool receptacle 3 to increase friction between surfaces of the tool receptacle 3 and the knife blade 22, thus preventing easy dislodgement of the knife blade 22 from the tool receptacle.

During use of the multifunctional scraper of the present embodiment by the operator, when there is a need to use the knife blade 22, he/she can take it out of the handle 2 for use. This can provide the operator with more options and greater convenience.

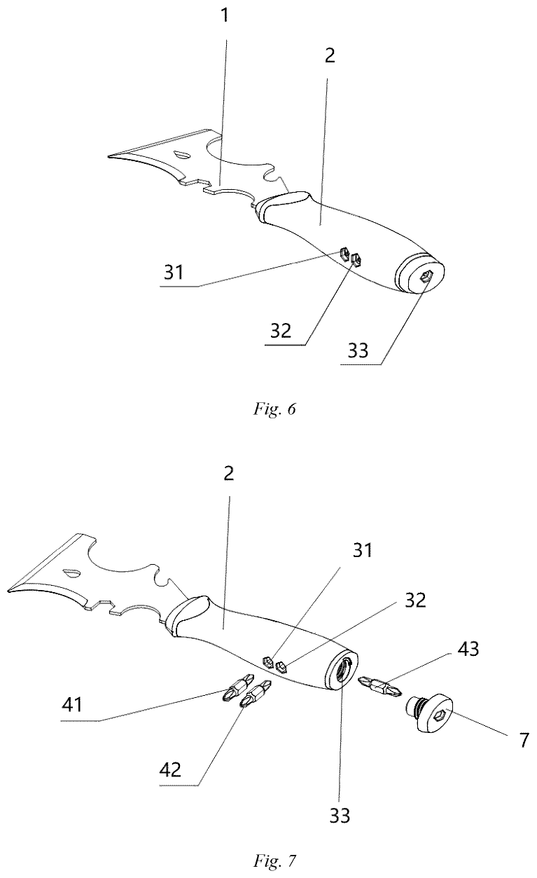

FIG. 6 is a schematic diagram showing the structure of a multifunctional scraper according to a further embodiment of the present application. The multifunctional scraper of the present embodiment includes a scraper blade 1 and a handle 2. The handle 2 is provided with three tool receptacles: a first tool receptacle 31 and a second tool receptacle 32, both transversely extending through the handle 2; and a third tool receptacle 33 provided at a trailing end of the handle 2 and extending longitudinally with respect to the handle 2.

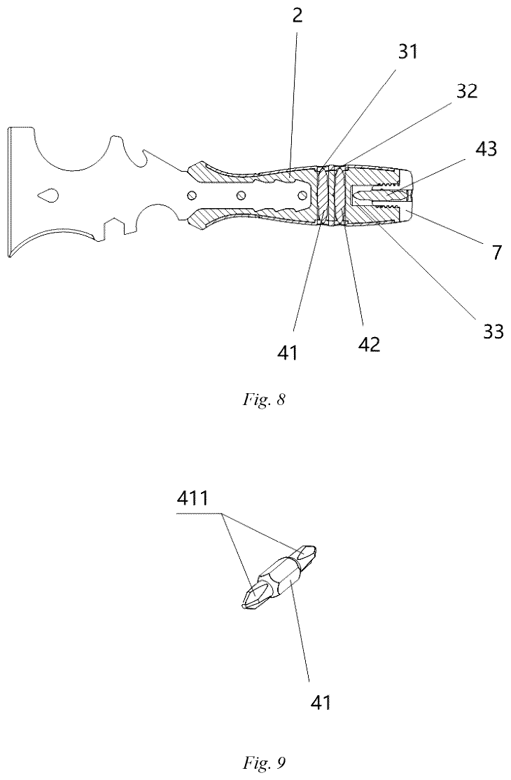

As shown in FIGS. 7 and 8, the first tool receptacle 31, the second tool receptacle 32 and the third tool receptacle 33 may accommodate the first linear screwdriver bit 41, the second linear screwdriver bit 42 and the third linear screwdriver bit 43, respectively.

For example, the first tool receptacle 31 and the second tool receptacle 32 both transversely extend through the handle 2 and form linear through holes. The first linear screwdriver bit 41 and the second linear screwdriver bit 42 may be movably inserted in the first tool receptacle 31 and the second tool receptacle 32, respectively, i.e., transversely received in the through holes in the handle 2.

Because of the structural nature of the through holes, the first linear screwdriver bit 41 and the second linear screwdriver bit 42 received therein can be conveniently removed from either side thereof.

Additionally, as shown in FIG. 7, an end cap 7 is provided at the trailing end of the handle 2. For example, the end cap 7 may be threadedly coupled to the trailing end of the handle 2. For example, the end cap 7 may be threadedly engaged with an inner wall of the third tool receptacle 33 at the trailing end of the handle 2. Alternatively, the end cap 7 may be secured to the inner wall of the third tool receptacle 33 at the trailing end of the handle 2 by an elastic element pressed against the inner wall.

When the end cap 7 is tightened at the trailing end of the handle 2, it will delimit, together with the longitudinal third tool receptacle 33, an enclosed cavity in which the third linear screwdriver bit 43 can be placed. When there is a need to use the third linear screwdriver bit 43 in the cavity, the end cap 7 can be turned and removed to allow the third linear screwdriver bit 43 to be accessed for use.

In order to more securely keep the first linear screwdriver bit 41, the second linear screwdriver bit 42 and the third linear screwdriver bit 43 in the first tool receptacle 31, the second tool receptacle 32 and the third tool receptacle 33, anti-slip silicone coatings are provided respectively on the inner walls of the first tool receptacle 31, the second tool receptacle 32 and the third tool receptacle 33. For example, the anti-slip silicone coatings may be formed by a coating process.

The first linear screwdriver bit 41, the second linear screwdriver bit 42 and the third linear screwdriver bit 43 described in the present embodiment are identically constructed as linearly-shaped screwdriver bits. Therefore, they are described with, e.g., the first linear screwdriver bit 41 as a representative example. As shown in FIG. 9, the first linear screwdriver bit 41 has bit working portions 411 at both ends, which have the same or different functions. For example, both the bit working portions 411 at the ends of the first linear screwdriver bit 41 may be Phillips screwdriver bit tips. Alternatively, one of them may be a Phillips screwdriver tip, and the other may be a straight screwdriver tip.

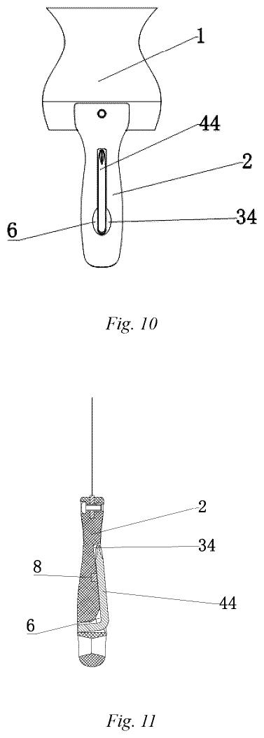

FIG. 10 is a schematic diagram showing the structure of a multifunctional scraper according to a further embodiment of the present application. The multifunctional scraper of the present embodiment includes a scraper blade 1, a handle 2 and an L-shaped bit tool 44. The L-shaped bit tool 44 serves as a second tool, and a tool receptacle 34 is provided in a middle portion of the handle 2. Wherein, the tool receptacle 34 is adapted to the L-shaped bit tool 44 in terms of shape and size. The L-shaped bit tool 44 can be movably inserted in the tool receptacle 34.

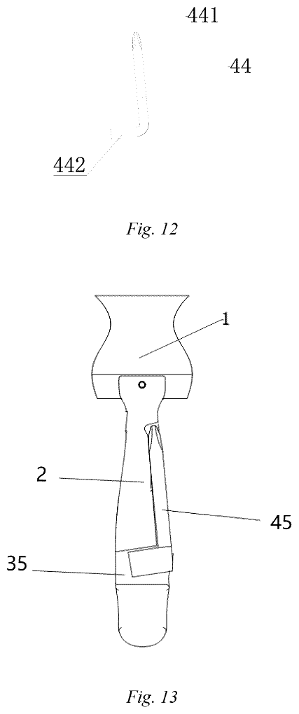

As shown in FIG. 11, a magnetic element 8 is embedded at the bottom of the tool receptacle 34. The magnetic element 8 may be magnetic steel and can retain the L-shaped bit tool 44 in the tool receptacle 34 by exerting an attractive magnetic force thereon, thus effectively avoiding the L-shaped bit tool 44 from slipping out of the tool receptacle 34.

The L-shaped bit tool 44 described in the present embodiment may, as shown in FIG. 12, define a bit working portion 441 and a crowbar claw 442 at its opposite ends. For example, the bit working portion 441 may be a Phillips screwdriver tip or a straight screwdriver tip.

In order to more securely keep the L-shaped bit tool 44 in the tool receptacle 34, an anti-slip silicone coating is provided on an inner wall of the tool receptacle 34. For example, the anti-slip silicone coating may be coated on the inner wall of the tool receptacle 34.

In order to enable the L-shaped bit tool 44 to be conveniently pulled and removed from or placed back into the tool receptacle 34, a curved depression 6 is provided around an externally exposed end of the tool receptacle 34. For example, the curved depression 6 may be formed by cutting around the externally exposed end of the tool receptacle 3.

FIG. 13 is a schematic cutaway view of a multifunctional scraper according to a further embodiment of the present application. The multifunctional scraper of the present embodiment includes a scraper blade 1, a handle 2 and a hammer 45. The hammer 45 serves as a second tool, and a tool receptacle 35 is provided in a middle portion of the handle 2. The tool receptacle 35 is adapted to the hammer 45 in terms of shape and size. The hammer 45 can be movably inserted in the tool receptacle 35.

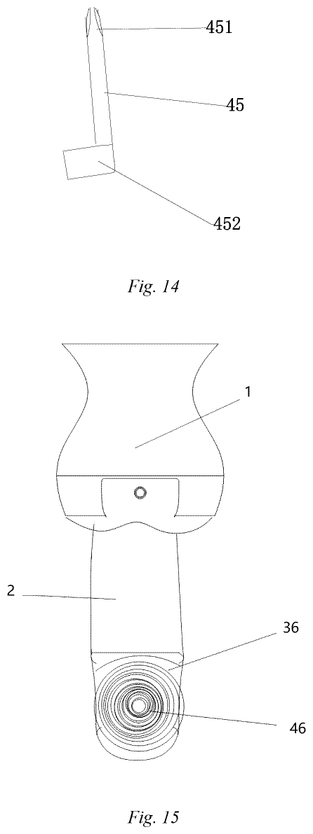

In the present embodiment, the hammer 45 may, as shown in FIG. 14, define a screwdriver bit 451 and a hammer working portion 452 at its opposite ends. For example, the screwdriver bit 451 may be a Phillips screwdriver tip or a straight screwdriver tip.

In order to more securely keep the hammer 45 in the tool receptacle 35, an anti-slip silicone coating is provided on an inner wall of the tool receptacle 35. For example, the anti-slip silicone coating may be coated on the inner wall of the tool receptacle 35.

FIG. 15 is a schematic diagram showing the structure of a multifunctional scraper according to a further embodiment of the present application. The multifunctional scraper of the present embodiment includes a scraper blade 1, a handle 2 and a tape measure 46. The tape measure 46 serves as a second tool, and a tool receptacle 36 is provided at a trailing end of the handle 2. The tool receptacle 36 is adapted to the tape measure 46 in terms of shape and size. The tape measure 46 can be movably inserted in the tool receptacle 36.

In order to more securely keep the tape measure 46 in the tool receptacle 36, an anti-slip silicone coating is provided on an inner wall of the tool receptacle 36. For example, the anti-slip silicone coating may be coated on the inner wall of the tool receptacle 36.

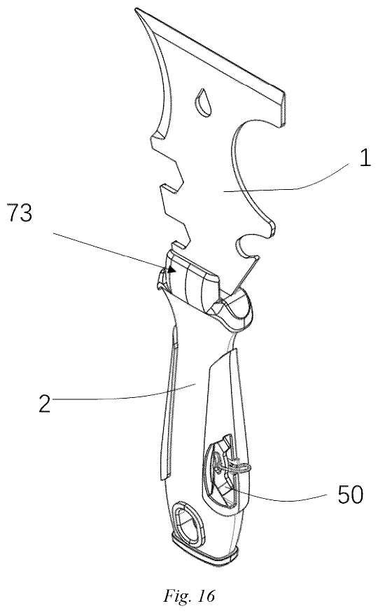

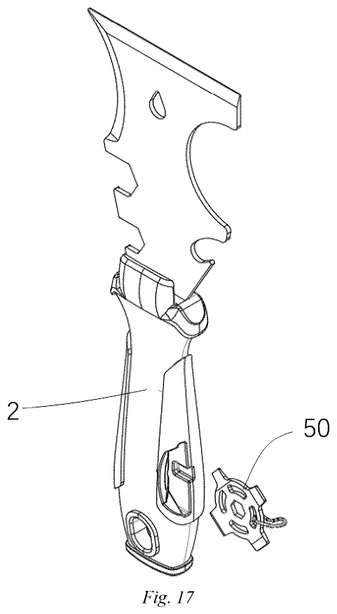

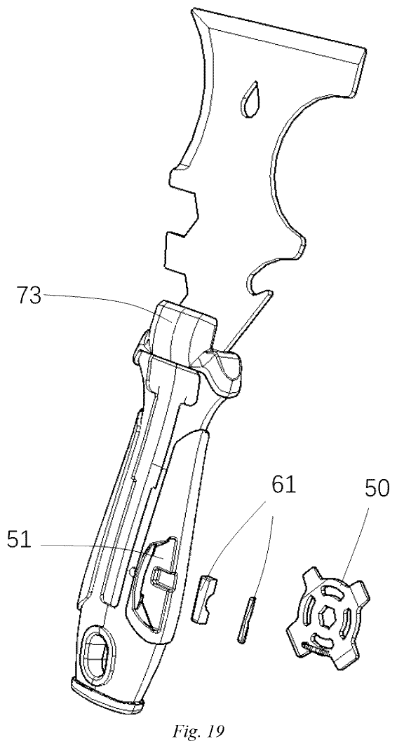

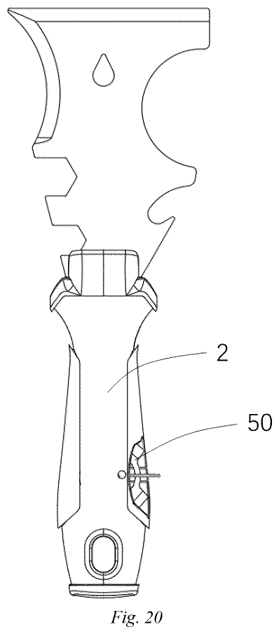

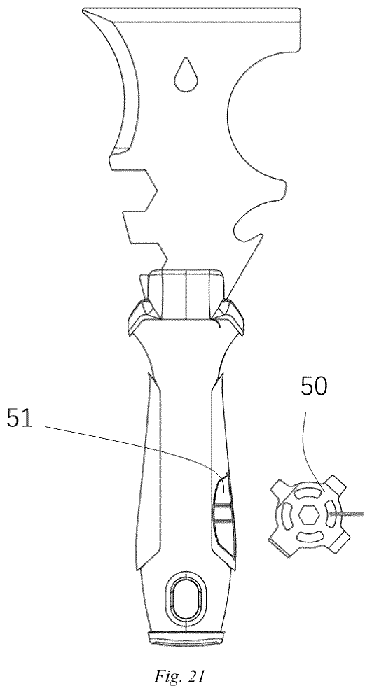

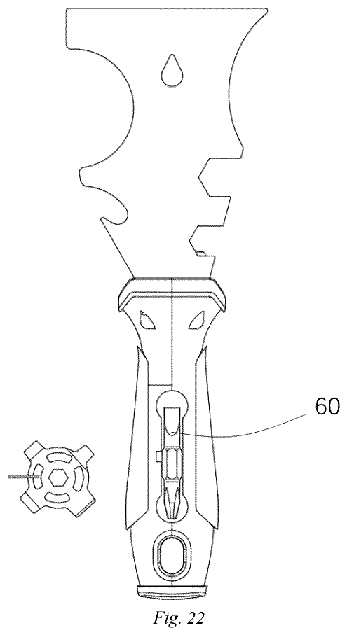

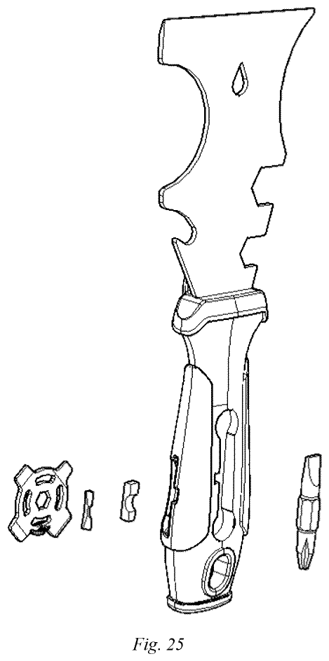

FIGS. 16 to 26 show a combination tool according to a further embodiment of the present application. FIG. 16 is a schematic diagram showing the structure of the combination tool, which includes a first tool component, a grip portion coupled to the first tool component, and at least one second tool component detachably disposed in the grip portion. The second tool component has a different function from that of the first tool component. In this embodiment, the combination tool may be a multifunctional scraper including a scraper blade 1 (as the first tool component), a handle 2 (as the grip portion) and at least one second tool component provided in the handle 2. If required in practical applications, any suitable number of second tool components of any suitable types may be used. For example, second tool components of more than one type may be provided in the handle 2. The scraper blade 1 and the handle 2 are of the same structure as those in the multifunctional scraper of FIGS. 1 to 2 and, therefore, need not be described in further detail herein. In this embodiment, as shown in FIG. 19, the second tool components provided in the handle 2 include a Phillips screwdriver bit 50 disposed in an associated tool receptacle in the handle 2. The Phillips screwdriver bit 50 can be movably inserted into the tool receptacle.

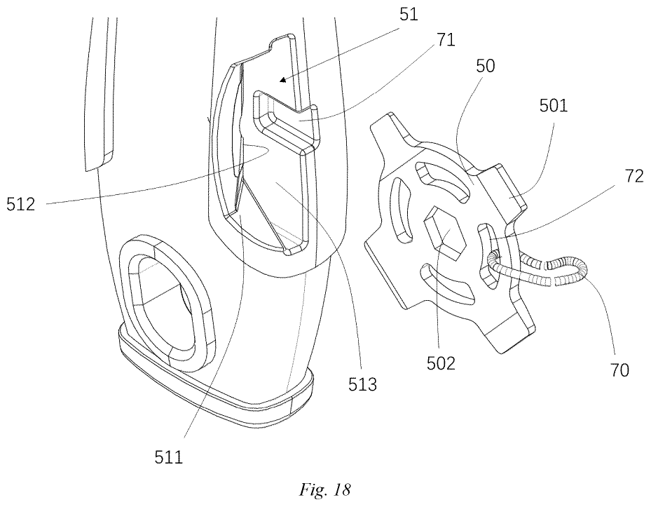

The Phillips screwdriver bit 50 is structured similarly to the Phillips screwdriver bit 50 of FIG. 4. Accordingly, it has four Phillips bit working portions 501, which are directed toward four different perpendicular directions. In order to provide the operator with more options and greater convenience, each Phillips bit working portion 211 may have a different function. The Phillips screwdriver bit 50 of this embodiment differs from that of FIG. 4 in that, as shown in FIG. 18, a central portion of the Phillips screwdriver bit 50 (which is a main body portion integrating the four working portions 501 into a single part) defines a through slot 502 extending therethrough in its direction of thickness. A separate screwdriver bit 60 can detachably engage in the through slot 502. When the separate screwdriver bit 60 is perpendicularly inserted into the through slot 502, an operator may rotate the Phillips screwdriver bit 50 to actuate the separate screwdriver bit 60. In other words, the Phillips screwdriver bit 50 can serve as an actuating handle for the separate screwdriver bit 60, and can be combined with the separate screwdriver bit 60 into a complete screwdriver. This can additionally expand the scope of application of the combination tool of this embodiment. Preferably, the through slot 502 is hexagonal, and the separate screwdriver bit 60 includes a cross-sectionally hexagonal shaft and a bit tip jointed to the shaft. The shaft matches the through slot in size and can be inserted into the through slot. The bit tip may be any common screwdriver bit known in the art. It will be understood that the present application is not limited to any particular shape of the through slot and the shaft, and any suitable shape or structure can be used herein as long as it enables the through slot and the shaft to remain stationary relative to each other in an intended direction of rotation.

The Phillips screwdriver bit 50 of this embodiment may be secured within the tool receptacle 51 in the handle 2 by virtue of any of the above discussed damping mechanisms shown in FIGS. 1 to 15. Possible embodiments of the damping mechanism may include, but are not limited to: (1) an anti-slip silicone coating applied to a side wall of the tool receptacle 51, which can create greater friction between the Phillips screwdriver bit 50 and the side wall of the receptacle 51, preventing the screwdriver bit 50 from dislodging from the receptacle 51; (2) a magnetic attraction means provided on the side wall of the tool receptacle 51, which can create a magnetic force for retaining the screwdriver bit 50; and (3) an elastic snap element 5 disposed at an opening of the receptacle 51 so as to protrude from the opening, which, when the screwdriver bit is inserted into the receptacle, comes into contact with and thereby retains screwdriver bit by means of elasticity. It will be understood that any other approach or configuration capable of retaining the Phillips screwdriver bit 50 within the receptacle may be suitably used herein, and the present application is not limited to any particular such approach or configuration.

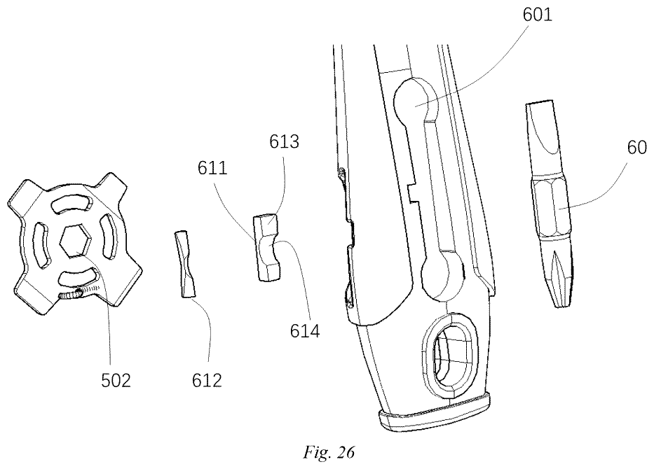

In a further embodiment, as shown in FIGS. 19 and 26, a retention insert 61 is provided in the tool receptacle 51, which, when the Phillips screwdriver bit 50 is inserted into the tool receptacle 51, can restrict, support and retain the Phillips screwdriver bit 50. The retention insert 61 may be disposed on a side wall 512 of the tool receptacle 51 in its direction of thickness so as to extend from the side wall 512 toward another side wall 513 in opposition. The Phillips screwdriver bit 50 can be inserted into the tool receptacle 51 so as to be located between the retention insert 61 and the other side wall 513 of the tool receptacle 51. In some implementations, the retention insert 61 includes a first retention insert 611 and a second retention insert 612, which are disposed in opposition to each other. The first retention insert moiety 611 is located proximate the bottom of the tool receptacle 51, while the second retention insert 612 is located proximate the opening of the tool receptacle 51 that opposes the bottom. Preferably, an end face of the second retention insert 612 is flush with the opening. The Phillips screwdriver bit 50 may be inserted into the tool receptacle 51 so that the first retention insert 611 and the second retention insert 612 support opposite ends of the Phillips screwdriver bit 50. In some implementations, the first retention insert 611 includes raised portions 613 at its opposite ends and a recessed portion 614 between the two raised portions 613. The raised portions 613 serve to support and retain the Phillips screwdriver bit 50. The second retention insert 612 is structured similarly to the first retention insert 611.

In some embodiments, in order to allow the Phillips screwdriver bit 50 to be more easily taken out of the tool receptacle 51, referring to FIG. 18, a notch 511 is provided on one side of the opening of the tool receptacle 51, through which a user can access the Phillips screwdriver bit 50 and take it out of the tool receptacle 51. In some embodiments, in order to allow the Phillips screwdriver bit 50 to be more easily taken out, a pull-out feature 70 may be provided on the Phillips screwdriver bit 50. For example, as shown, the pull-out feature 70 may include a pull-out means provided on the Phillips screwdriver bit 50, and a user can take the Phillips screwdriver bit 50 out by exerting a force on the pull-out means. In addition, in order to facilitate stowing of the pull-out means and prevent it from being exposed outside the handle 2, an avoidance feature 71 may be provided on the side of the opening opposite to the notch 511. Preferably, the avoidance feature 71 takes the form of a depression formed in the side wall 513. When the Phillips screwdriver bit 50 is inserted in the tool receptacle 51, the pull-out means can be stowed in the avoidance feature 71. The pull-out means may be in the form of a rope, loop, ring or the like. In the illustrated embodiment, the pull-out means is a loop formed by a thread passed through a slot 72 in the Phillips screwdriver bit 50.

In order to facilitate stowing of the separate screwdriver bit 60 for use with the Phillips screwdriver bit 50, referring to FIG. 22, the handle 2 may define a tool receptacle 601, in which the screwdriver bit can be received. With this arrangement, both the Phillips screwdriver bit 50 and the corresponding separate screwdriver bit 60 can be stowed conveniently. The Phillips screwdriver bit 50 can be used either separately or in combination with the separate screwdriver bit 60, expanding the scope of application. It will be understood that the screwdriver bit 60 may also be used with a different screwdriver bit. The tool receptacle may be of the same structure as is shown in FIG. 7. That is, a receptacle 31 and/or 32 for receiving the screwdriver bit may be formed in a side surface of the handle 2, and the screwdriver bit may be stored in the receptacle 31 and/or 32. In FIG. 7, the tool receptacle defines a lengthwise direction perpendicular to the side surface of the handle 2, and the screwdriver bit is stored in the handle 2 in an orientation perpendicular to the handle 2. In another embodiment, the tool receptacle 601 may extend parallel to the side surface of the handle 2, i.e., in parallel to a lengthwise direction of the handle 2, and the screwdriver bit can be received in the receptacle. In order to firmly retain the screwdriver bit 60 in the tool receptacle 601, one or more damping mechanisms may be provided in the tool receptacle 601. These damping mechanisms may function in the same or similar way as those for retaining the Phillips screwdriver bit 50 as described above and, therefore, need not be described in further detail herein.

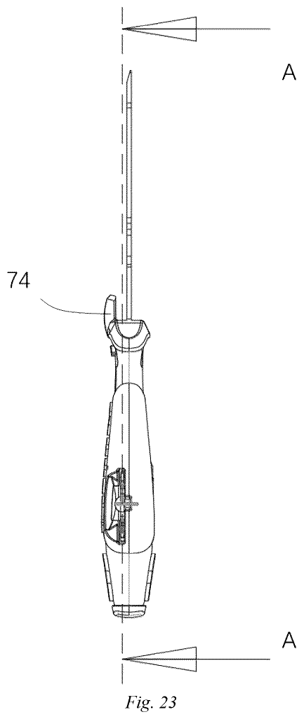

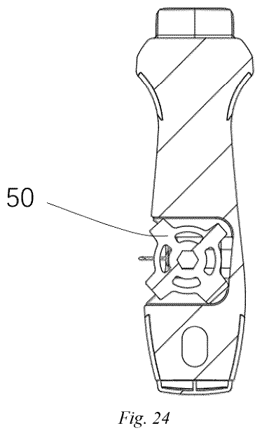

In some embodiments, referring to FIGS. 19 and 23, a can opener 73 for opening a cover of a container in the form of a can, such as a paint can, is provided on the handle 2 at its end proximate the scraper blade. Preferably, the handle 2 defines a protrusion 74 extending from its end in opposition to the scraper blade 1. The scraper 1 serves as a lever member of the can opener 83, and the protrusion 74 is intended to be brought into contact with a cover of a container in the form of a can, providing a point of force application. With this arrangement, the cover of the container can be easily removed. In other words, the protrusion and the scraper blade make up an extractor.

In this embodiment, the handle provides a larger storage space, in which various other tools having a different function from that of the first working portion can be stored. Integrating a variety of tools in a single unit in this way allows convenient carrying, expands the scope of application and enables easy operation. Meanwhile, the other tools can be well retained by respective features of the handle. This allows both convenient carrying and easy removal of the tools.

A Multifunctional scraper provided in the present application has been detailed and introduced above. Specific examples are presented herein to explain the principles and embodiments of the multifunctional scraper provided in this application, and the description of the foregoing embodiments is intended only to help understand the method of this application and its core concept. It is noted that a number of improvements and modifications can be made to the application by those of ordinary skill in the art without departing from the principles thereof. Accordingly, it is intended that these improvements and modifications are also embraced in the protection scope of the claims of this application.

1. A combination tool, characterized in comprising:
a first tool component comprising a working portion and a grip portion, which are coupled to each other, the grip portion defining a tool receptacle;
at least one second tool component having a different function from that of the tool component, the second tool component detachably engaged in the tool receptacle; and
a damping mechanism configured to prevent the second tool component from dislodging from the grip portion in the absence of an external force acting thereon.

2. The combination tool according to claim 1, characterized in that the second tool component comprises a Phillips screwdriver bit, which is a screwdriver bit with four Phillips bit working portions extending in four mutually perpendicular directions.

3. The combination tool according to claim 2, characterized in that the Phillips screwdriver bit defines a through slot in its central portion, which is configured to detachably engage a first screwdriver bit and actuate rotation of the first screwdriver bit under an action of an external force.

4. The combination tool according to claim 3, characterized in that the first screwdriver bit is received in a working receptacle in the grip portion.

5. The combination tool according to claim 4, characterized in that the working receptacle extends in a lengthwise direction of the grip portion.

6. The combination tool according to claim 2, characterized in that a retention insert is provided on a side wall in the tool receptacle and is configured to come into contact with the Phillips screwdriver bit and restrict and support the Phillips screwdriver bit.

7. The combination tool according to claim 6, characterized in that the retention insert comprises a first retention insert and a second retention insert, which are separate from and arranged in opposition to each other and come into contact with respective opposite ends of the Phillips screwdriver bit.

8. The combination tool according to claim 7, characterized in that the first retention insert and the second retention insert each comprise raised portions at opposite ends and a recessed portion between the raised portions, the raised portions configured to come into contact with the Phillips screwdriver bit.

9. The combination tool according to claim 2, characterized in that the Phillips screwdriver bit is provided with a pull-out feature configured for the Phillips screwdriver bit to be pulled out of the tool receptacle under an action of an external force.

10. The combination tool according to claim 9, characterized in that the pull-out feature is a rope-like feature passed through a slot in the Phillips screwdriver bit.

11. The combination tool according to claim 10, characterized in that the tool receptacle defines, in its side wall, an avoidance feature capable of receiving the rope-like feature therein.

12. The combination tool according to claim 1, characterized in that the grip portion defines, at its end proximate the first working portion, an extraction component configured to be able to open a cover of a container in the form of a can under an action of an external force.

13. The combination tool according to claim 12, characterized in that the extraction component comprises a protrusion extending from the end of the grip portion in a lengthwise direction of the grip portion, the protrusion in opposition to the first tool component, wherein the first tool component forms a lever member of the extraction component, and the protrusion provides a point of force application for the extraction component.

14. The combination tool according to claim 1, characterized in that the first tool component is a scraper.

15. The combination tool according to claim 1, characterized in that the damping mechanism comprises:
a protruding snap element provided at an opening of the tool receptacle; and/or
an anti-slip coating provided inside the tool receptacle; or/or
a magnetic attraction means provided in the tool receptacle.

16. A combination tool characterized in comprising:
a first tool component comprising a working portion and a grip portion, which are coupled to each other, the grip portion defining a tool receptacle;
at least one second tool component having a different function from that of the tool component, the second tool component detachably engaged in the tool receptacle,
wherein the second tool component comprises a Phillips screwdriver bit detachably received in the tool receptacle; and
a retention insert disposed in the tool receptacle to restrict and support the Phillips screwdriver bit in the tool receptacle.

17. The combination tool according to claim 16, characterized in that the retention insert comprises a first retention insert and a second retention insert, which are disposed on an inner wall of the tool receptacle.

18. The combination tool according to claim 16, characterized in that the Phillips screwdriver bit defines a through slot in its central portion, which is configured to detachably engage a first screwdriver bit, and is configured to actuate rotation of the first screwdriver bit under an action of an external force.

19. The combination tool according to claim 17, characterized in that the first screwdriver bit is detachably engaged in a working receptacle in the grip portion.

20. The combination tool according to claim 16, characterized in that the grip portion is provided at its end proximate the first working portion with an extraction component configured to be able to open a cover of a container in the form of a can under an action of an external force.
